(19) United States
(12) Patent Application Publication
(10) Pub. No.: US 2025/0046123 A1
(43) Pub. Date: Feb. 6, 2025

(54) BIOMETRIC DETERMINATION APPARATUS, BIOMETRIC DETERMINATION METHOD, AND NON-TRANSITORY RECORDING MEDIUM

(71) Applicant: NEC Corporation, Minato-ku, Tokyo (JP)

(72) Inventors: Haruki IMAI, Tokyo (JP); Kapik LEE, Tokyo (JP)

(73) Assignee: NEC Corporation, Minato-ku, Tokyo (JP)

(21) Appl. No.: 18/719,363

(22) PCT Filed: Dec. 16, 2021
(86) PCT No.: PCT/JP2021/046442

§ 371 Date: Jun. 13, 2024

(51) Int. Cl. G06V 40/40; G06V 40/16

(52) U.S. Cl. CPC G06V 40/40; G06V 40/171; G06V 40/172

(57) ABSTRACT

Provided are: a covered area determination unit that determines whether or not a face area including a face of a target person captured in an image generated by imaging the target person includes a covered area that covers at least partial area of the face; a first determination unit that determines whether or not the target person is a living body by a first determination method using the image, in a case where the covered area determination unit determines that the face area does not include the covered area; and a second determination unit that determines whether or not the target person is a living body by a second determination method that uses the image and that is different from the first determination method, in a case where the covered area determination unit determines that the face area includes the covered area.

### TECHNICAL FIELD

This disclosure relates to technical fields of a biometric determination apparatus, a biometric determination method, and a recording medium.

### BACKGROUND ART

Patent Literature 1 describes a technique/technology of allowing a user performing face recognition to select a face part as a target from which a feature quantity is extracted, for placing importance on the feature quantity of the selected part while reducing feature quantities of other parts to properly recognize a face even when the user wears a mask/eye patch or makes change in a hairstyle. Patent Literature 2 describes a technique/technology of: calculating a likelihood value p1 showing object-likeliness by using a machine learning system configured to learn to respond to the image of an object shown by a pickup image, the object wearing a mask and the object not wearing any mask; calculating a likelihood value p2 showing object-likeliness wearing the mask by using the machine learning system configured to learn to respond to the image of the object wearing the mask; calculating a likelihood value p3 showing object-likeliness by using the machine learning system configured to respond to the image of the object not wearing the mask; and deciding whether or not the object shown by the pickup image is wearing the mask on the basis of the calculated three likelihood values p1, p2 and p3. Patent Literature 3 describes a technique/technology including the steps of: detecting a face area from an input image showing an input face; generating a composite image by combining a face image and a reference image on the basis of a masking region; determining face features corresponding to the input face on the basis of the face image and the composite image; and determining success or failure of authentication on the basis of the determined face features.

### CITATION LIST

### Patent Literature

Patent Literature 1: JP2007-257221A
Patent Literature 2: JP2010-003116A
Patent Literature 3: JP2018-165980A

### SUMMARY

### Technical Problem

It is an example object of this disclosure to provide a biometric determination apparatus, a biometric determination method, and a recording medium that aim to improve the techniques/technologies disclosed in Citation List.

### Solution to Problem

A biometric determination apparatus according to an example aspect of this disclosure includes: a covered area determination unit that determines whether or not at least a partial area of a face area including a face of a target person in an image is covered; a first determination unit that determines whether or not the target person is a living body by a first determination method using the image, in a case where the face area is not covered; and a second determination unit that determines whether or not the target person is a living body by a second determination method that uses the image and that is different from the first determination method, in a case where the face area is covered.

A biometric determination method according to an example aspect of this disclosure includes: determining whether or not at least a partial area of a face area including a face of a target person in an image is covered; determining whether or not the target person is a living body by a first determination method using the image, in a case where the face area is not covered; and determining whether or not the target person is a living body by a second determination method that uses the image and that is different from the first determination method, in a case where the face area is covered.

A recording medium according to an example aspect of this disclosure is a recording medium on which a computer program that allows a computer to execute a biometric determination method is recorded, the biometric determination method including: determining whether or not at least a partial area of a face area including a face of a target person in an image is covered; determining whether or not the target person is a living body by a first determination method using the image, in a case where the face area is not covered; and determining whether or not the target person is a living body by a second determination method that uses the image and that is different from the first determination method, in a case where the face area is covered.

### BRIEF DESCRIPTION OF DRAWINGS

FIG. 1 is a block diagram illustrating a configuration of a biometric determination apparatus 1 in a first example embodiment.

FIG. 2 is a block diagram illustrating a configuration of a biometric determination system 2 in a second example embodiment.

FIG. 3 is a flowchart illustrating a flow of a biometric determination operation performed by a biometric determination apparatus 20 in the second example embodiment.

FIG. 4 is a conceptual diagram of face information detection in the second example embodiment.

FIG. 5 is a conceptual diagram of an image part in the second example embodiment.

FIG. 6 is a conceptual diagram of a second image part in the second example embodiment.

FIG. 7 is a conceptual diagram of light emission control in a third example embodiment.

FIG. 8 is a block diagram illustrating a configuration of an authentication system 4 in a fourth example embodiment.

FIG. 9 is a flowchart illustrating a flow of a biometric determination operation and a biometric authentication operation performed by an authentication apparatus 40 in the fourth example embodiment.

FIG. 10 is a conceptual diagram of an image part in the fourth example embodiment.

### DESCRIPTION OF EXAMPLE EMBODIMENTS

Hereinafter, a biometric determination apparatus, a biometric determination method, and a recording medium according to example embodiments will be described with reference to the drawings.

### 1: First Example Embodiment

First, a biometric determination apparatus, a biometric determination method, and a recording medium according to a first example embodiment will be described. The following describes the biometric determination apparatus, the biometric determination method, and the recording medium according to the first example embodiment, by using a biometric determination apparatus 1 to which the biometric determination apparatus, the biometric determination method, and the recording medium according to the first example embodiment are applied.

### [1-1: Configuration of Biometric Determination Apparatus 1]

FIG. 1 is a block diagram illustrating a configuration of the biometric determination apparatus 1 in the first example embodiment. As illustrated in FIG. 1, the biometric determination apparatus 1 includes a covered area determination unit 11, a first determination unit 12, and a second determination unit 13. The biometric determination apparatus 1 may perform biometric determination by using information that may be acquired from a face area including a face of a target person captured in an image generated by imaging the target person. The biometric determination apparatus 1 may determine whether the target person is a living body or a counterfeit of another person who is impersonated by the target person, by using information that may be acquired from the face area. The counterfeit of another person may include a planar-shaped object such as a photograph in which another person is captured and a display in which another person is displayed, and a three-dimensional object such as a doll imitating another person and a face mask of silicon or the like. The biometric determination performed by the biometric determination apparatus 1 may be liveness determination that determines whether the target person himself/herself is actually captured.

The covered area determination unit 11 determines whether or not the face area including the face of the target person captured by the image generated by imaging the target person, includes a covered area that covers at least a partial area of the face.

In a case where the covered area determination unit 11 determines that the face area does not include the covered area, the first determination unit 12 determines whether or not the target person is a living body by using a first determination method using an image. The first determination method may be a method suitable for determining whether or not the target person is a living body in a case where the face area does not include the covered area

In a case where the covered area determination unit 11 determines that the face area includes the covered area, the second determination unit 13 determines whether or not the target person is a living body by using a second determination method that uses an image and that is different from the first determination method. The second determination method may be a method suitable for determining whether or not the target person is a living body in a case where the face area includes the covered area.

The covered area that covers at least a partial area of the face in the face area, may not be used for the biometric determination. Therefore, in a case where the face area includes the covered area, an amount of information that can be acquired from the face area may be smaller than that in a case where the face area does not include the covered area. Therefore, the biometric determination apparatus 1 in the first example embodiment determines whether or not the target person is a living body by different determination methods in a case where the face area does not include the covered area and in a case where the face area includes covered area.

### [1-2: Technical Effect of Biometric Determination Apparatus 1]

Since the biometric determination apparatus 1 in the first example embodiment determines whether or not the target person is a living body by different determination methods in a case where the face area does not include the covered area and in a case where the face area includes covered area, it is possible to accurately perform the biometric determination in the both cases, i.e., in a case where the face area does not include the covered area and in a case where the face area includes covered area.

### 2: Second Example Embodiment

Next, a biometric determination apparatus, a biometric determination method, and a recording medium according to a second example embodiment will be described. The following describes the biometric determination apparatus, the biometric determination method, and the recording medium according to the second example embodiment, by using a biometric determination system 2 including a biometric determination apparatus 20 to which the biometric determination apparatus, the biometric determination method, and the recording medium according to the second example embodiment are applied.

### [2-1: Configuration of Biometric Determination System 2]

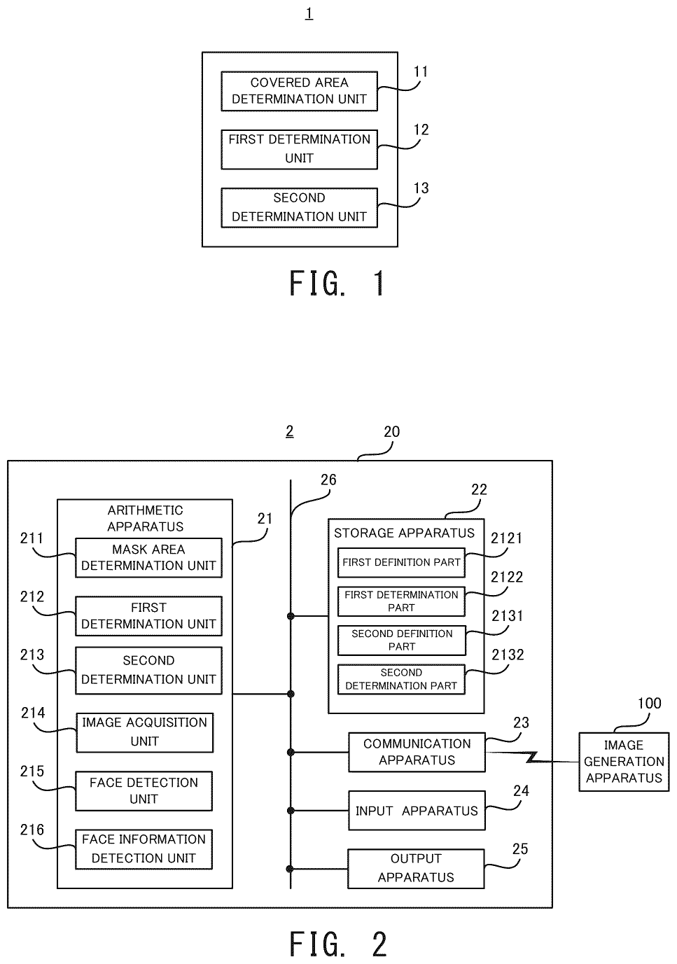

With reference to FIG. 2, a configuration of the biometric determination system 2 in the second example embodiment will be described. FIG. 2 is a block diagram illustrating the configuration of the biometric determination system 2 in the second example embodiment. The biometric determination system 2 in the second example embodiment may be applied, for example, to biometric determination in authentication at a gate, biometric determination in walkthrough authentication, and the like.

As illustrated in FIG. 2, the biometric determination system 2 includes the biometric determination apparatus 20 and an image generation apparatus 100. The biometric determination system 2 may include a single image generation apparatus 100 or may include a plurality of image generation apparatuses 100. The biometric determination apparatus 20 and the image generation apparatus 100 are allowed to communicate with each other through a communication network. The communication network may include a wired communication network. The communication network may include a wireless communication network. The image generation apparatus 100 is an imaging apparatus that is configured to image the target person located in an imaging target range of the image generation apparatus 100. The target person is a person and a living body. The image generation apparatus 100 images the target person, thereby to generate an image IMG in which the target person imaged by the image generation apparatus 100 is captured. In particular, the image generation apparatus 100 images the face of the target person, thereby to generate the image IMG in which the face of the target person is captured. The image generation apparatus 100 outputs the generated image IMG to the biometric determination apparatus 20. Specifically, the image generation apparatus 100 transmits the generated image IMG to the biometric determination apparatus 20 through the communication network.

The image generation apparatus 100 may image the target person, thereby to generate the image IMG including information indicating a body surface temperature distribution of the target person imaged by the image generation apparatus 100. In this case, the image IMG may be an image indicating, by color or gradation, the body surface temperature distribution of the target person. Alternatively, the image generation apparatus 100 may image the target person, thereby to generate the image IMG including information indicating a distance from the image generation apparatus 100 to the target person. In this instance, the image IMG may be an image indicating, by color or gradation, a distance information distribution from the image generation apparatus 100 to the target person. The image IMG may be an image such as infrared image, a thermal image, and a depth image. In the second example embodiment, a case where the image generation apparatus 100 generates the image IMG including information indicating the body surface temperature distribution of the target person will be described as an example.

The image IMG may include an image generated by the image generation apparatus 100 imaging a target person who does not have an intention to be desirably imaged by the image generation apparatus 100. The image IMG may include an image generated by the image generation apparatus 100 imaging a target person that has an intention to be desirably imaged by the image generation apparatus 100.

The biometric determination apparatus 20 determines whether the target person in front of the image generation apparatus 100 is a living body or a counterfeit of another person who is impersonated by the target person, on the basis of the image IMG received. Thus, the biometric determination apparatus 20 is capable of determining whether or not the target person impersonates or pretends to be a different person from the target person. The counterfeit of another person may include a planar-shaped object such as a photograph in which another person is captured and a display in which another person is displayed, and a three-dimensional object such as a doll imitating another person and a face mask of silicon or the like.

As illustrated in FIG. 2, the biometric determination apparatus 20 includes an arithmetic apparatus 21 and a storage apparatus 22. Furthermore, the biometric determination apparatus 20 may include a communication apparatus 23, an input apparatus 24, and an output apparatus 25. The biometric determination apparatus 20, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the biometric determination apparatus 20 (e.g., the input apparatus 24 described later). The arithmetic apparatus 21 may acquire (i.e., download or read) a computer program from a not-illustrated apparatus disposed outside the biometric determination apparatus 20 through the communication apparatus 23 (or another communication apparatus). The arithmetic apparatus 21 executes the read computer program. Consequently, a logical functional block for performing an operation to be performed by the biometric determination apparatus 20 is realized or implemented in the arithmetic apparatus 21. That is, the arithmetic apparatus 21 is allowed to function as a controller for realizing or implementing the logical function block for performing an operation (in other words, processing) to be performed by the biometric determination apparatus 20.

FIG. 2 illustrates an example of the logical functional block realized or implemented in the arithmetic apparatus 21 to perform a biometric determination operation. As illustrated in FIG. 2, a mask area determination unit 211 that is a specific example of the “covered area determination unit”, a first determination unit 212 that is a specific example of the “first determination unit”, a second determination unit 213 that is a specific example of the “second determination unit”, an image acquisition unit 214, a face detection unit 215, and a face information detection unit 216 are realized or implemented in the arithmetic apparatus 21.

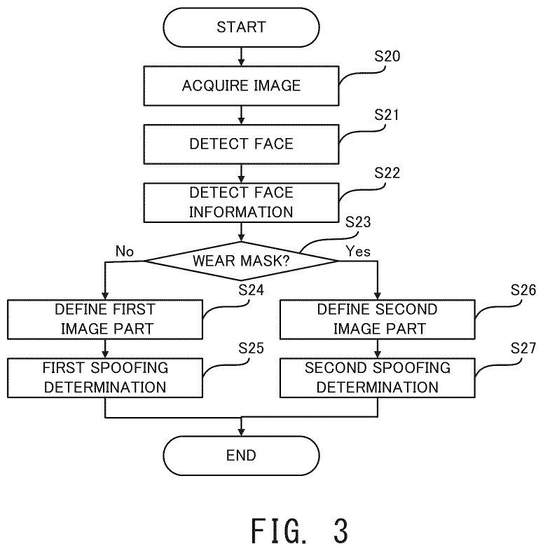

Details of operations of each of the mask area determination unit 211, the first determination unit 212, the second determination unit 213, the image acquisition unit 214, the face detection unit 215, and the face information detection unit 216 will be described later with reference to FIG. 3 to FIG. 6.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the biometric determination apparatus 20 for a long time. The storage apparatus 22 may include a at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The storage apparatus 22 may store a first definition part 2121 used by the first determination unit 212 for an area definition operation, a first determination part 2122 used by the first determination unit 212 for a spoofing determination operation, a second definition part 2131 used by the second determination unit 213 for the area definition operation, and a second determination part 2132 used by the second determination unit 213 for the spoofing determination operation.

The first definition part 2121 may be a definition part that defines a first image part R1 of the image IMG including at least a part of a face area FR. The second definition part 2131 may be a definition part that defines a second image part R2 obtained by removing at least a part of a mask area MR from the first image part R1. The second definition part 2131 may be a definition part that defines a size of the second image part R2 to be extracted and a position of the second image part R2, on the basis of a distance between the eyes included in the face. Furthermore, the second definition part 2131 may be a definition part that defines a lower limit part of the second image part R2 to be extracted, on the basis of both side parts of a lower part of the dorsum of the nose included in the face. The first determination part 2122 may be a determination part that determines whether or not the target person who is not wearing a mask is a living body. The first determination part 2122 may be a determination part constructed by machine learning of the determination of whether or not the target person is a living body by using the face image of the face without a mask. The second determination part 2132 may be a determination part that determines whether or not the target person who is wearing a mask is a living body. The second determination part 2132 may be a determination part constructed by machine learning of the determination of whether or not the target person is a living body by using the face image of the face with a mask. That is, the two determination parts may be prepared: the first determination part 2122 that performs machine learning by using the face image of the face without a mask, and the second determination part 2132 that performs machine learning by using the face image of the face with a mask.

The communication apparatus 23 is configured to communicate with an apparatus external to the biometric determination apparatus 20 through a not-illustrated communication network. The communication apparatus 23 may acquire the image IMG used for the biometric determination operation through the communication network.

The input apparatus 24 is an apparatus that receives an input of information to the biometric determination apparatus 20 from an outside of the biometric determination apparatus 20. For example, the input apparatus 24 may include an operating apparatus (e.g., at least one of a keyboard, a mouse, and a touch panel) that is operable by an operator of the biometric determination apparatus 20. For example, the input apparatus 24 may include a reading apparatus that is configured to read information recorded as data on a recording medium that that is externally attachable to the biometric determination apparatus 20.

The output apparatus 25 is an apparatus that outputs information to the outside of the biometric determination apparatus 20. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) that is configured to print desired information on the paper surface.

### [2-2: Biometric Determination Operation Performed by Biometric Determination Apparatus 20]

Next, with reference to FIG. 3 to FIG. 6, the biometric determination operation performed by the biometric determination apparatus 20 in the second example embodiment will be described.

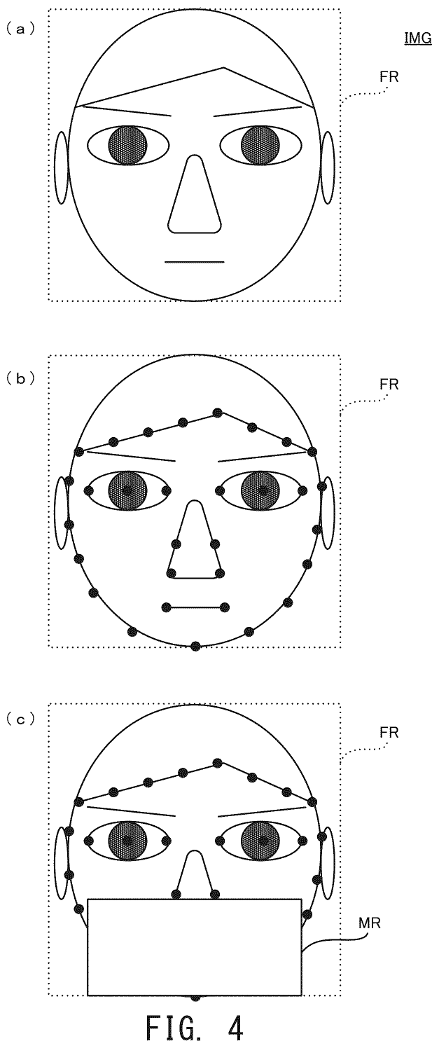

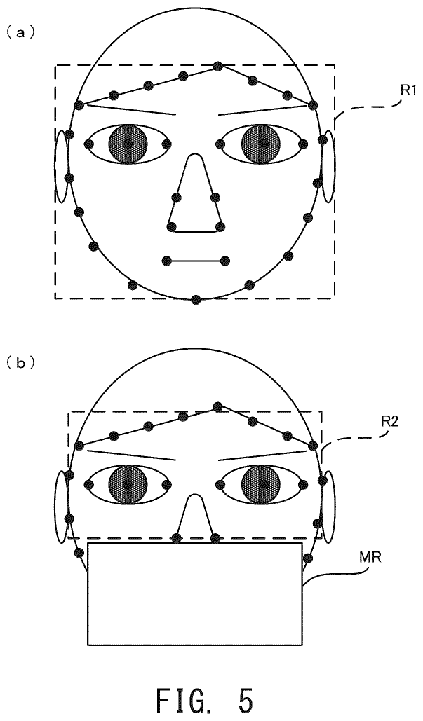

With reference to FIG. 3, a flow of the biometric determination operation performed by the biometric determination apparatus 20 in the second example embodiment will be described. FIG. 3 is a flowchart illustrating the flow of the biometric determination operation performed by the biometric determination apparatus 20 in the second example embodiment. FIG. 4 is a conceptual diagram of face information detection in the second example embodiment. FIG. 5 is a conceptual diagram of an image part in the second example embodiment.

As illustrated in FIG. 3, the image acquisition unit 214 acquires the image IMG from the image generation apparatus 100 through the communication apparatus 23 and the communication network (step S20).

The face detection unit 215 detects the face area FR including the face of the target person captured in the image IMG generated by imaging the target person (step S21). The face detection unit 215 may detect the face area FR including the face of the target person illustrated in FIG. 4(a), for example.

The face information detection unit 216 detects feature points from the face area FR including the face of the target person (step S22). The face information detection unit 216 may detect, for example, the feature points indicated by black circles illustrated in FIG. 4(b) and FIG. 4(c) from the face area FR. The black circles illustrated in FIG. 4(b) and FIG. 4(c) may be facial feature points. The facial feature point may be at least one of points corresponding to a pupil center, nose wings, corners of the mouth, the contour of the face, the end of hair, and the like.

The mask area determination unit 211 determines whether or not the face area FR includes the covered area that covers at least a partial area of the face (step S23). The covered area may be the mask area MR covered by a mask on the face. The mask area determination unit 211 may determine whether or not the face area FR includes the mask area MR covered by a mask on the face. The mask area determination unit 211 may determine that the mask area MR is not included, in a case where the feature points such as the nose wings and the corners of the mouth are detected from the face area FR as illustrated in FIG. 4(b), for example. In addition, the mask area determination unit 211 may determine that the mask area MR is included, in a case where the feature points such as the nose wings and the corners of the mouth are not detected from the face area FR as illustrated in FIG. 4(c), for example. In the second example embodiment, the mask area MR hidden by a mask may be a predetermined area including the nose wings, the corners of the mouth or the like, and the biometric determination apparatus 20 may perform the biometric determination operation on the premise that the surroundings of the eyes are not hidden by a mask. The first determination part 2122 may determine whether or not the target person is a living body on the basis of a temperature distribution in the first image part R1.

The biometric determination apparatus 20 in the second example embodiment may detect whether or not the target person is wearing a mask, and may switch between a definition operation of deciding the image part and the spoofing determination operation. That is, the biometric determination apparatus 20 may include a mechanism for properly switching between the operation by the first definition part 2121 and the first determination part 2122, or the operation by the second definition part 2131 and the second determination part 2132, depending on whether or not the target person is wearing a mask.

When the mask area determination unit 211 determines that the face area FR does not include the covered area (the step S23: No), the first determination unit 212 defines an area by using the first definition part 2121 (step S24), and determines whether or not the target person is a living body by the first determination method using the image IMG, by using the first determination part 2122 (step S25). The first determination method may be a method of determining whether or not the target person is a living body, by using the first image part of the image IMG including at least a part of the face area FR. The first determination method may be a method of determining whether or not the target person is a living body, by using the first definition part 2121 that is configured to output a determination result of whether or not the target person is a living body when the image IMG is inputted. The first definition part 2121 may define the first image part R1 to be inputted to the first determination part 2122. The first determination unit 212 may define, as the first image part R1, an area that is surrounded by a dashed line and that includes an area including the feature points, which is, for example, illustrated in FIG. 5 (a).

When the mask area determination unit 211 determines that the face area FR includes the covered area (the step S23: Yes), the second determination unit 213 defines the second image part R2 by using the second definition part 2131 (step S26), and determines whether or not the target person is a living body, by the second determination method that uses the image IMG and that is different from the first determination method, by using the second determination part 2132 (step S27). The second definition part 2131 may define, as the second image part R2, an area that is surrounded by a dashed line and that includes an area including the feature points, which is, for example, illustrated in illustrated in FIG. 5(b).

For example, the second definition part 2131 may define, as the second image part R2, an area that is above an area determined to be the nose, in a skin part in the image IMG. The second definition part 2131 may define an area that is below the hair and that is above the nose, by using face information, and may determine it to be the second image part R2 to be inputted to the second determination part 2132.

### [2-3: Definition Operation of Deciding Second Image Part R2 Performed by Second Definition Part 2131]

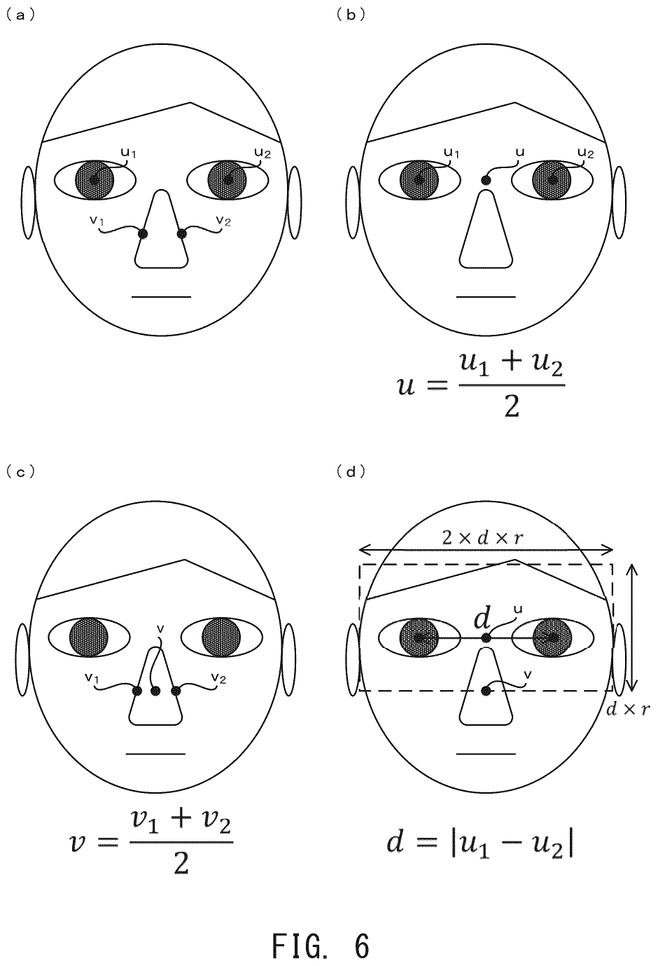

The second definition part 2131 may extract the second image part R2 from the face area FR on the basis of the distance between the eyes included in the face. The second definition part 2131 may extract the second image part R2 from the face area FR on the basis of both side parts of a lower part of the dorsum of the nose included in the face. With reference to FIG. 6, a specific method of deciding the second image part R2 in a case where the target person is wearing a mask, is exemplified. FIG. 6 illustrates the definition method of deciding the second image part R2 using facial feature points related to the eyes and the nose.

As illustrated in FIG. 6(a), first, coordinates of eye centers (u₁ coordinates and u₂ coordinates) and coordinates of nose feature points (v₁ coordinates and v₂ coordinates) are defined. As the nose feature points, both side parts of a lower part of the dorsum of the nose, which is a lower limit part of an area that is not covered by a mask, may be detected.

As illustrated in FIG. 6(b), a center of an attention area (u coordinates) is calculated from the coordinate of the eye centers (u₁ coordinates and u₂ coordinates). As illustrated in FIG. 6(c), a lower limit of the attention area (v coordinates) is calculated from the coordinates of the nose feature points (v₁ coordinates and v₂ coordinates). As illustrated in FIG. 6(d), an eye distance or eye spacing (d) is calculated. Using the center of the attention area (u coordinate), the lower limit of the attention area (v coordinate), and the eye distance (d) that are calculated, an area with a vertical distance of “d×r” and a horizontal distance of “2×d×r” is assumed to be the second image part R2. “r” is a parameter that controls a size of the area.

The second determination method may be a method of determining whether or not the target person is a living body, by using the second image part R2 in which at least a part of the covered area is removed from the first image part R1. The second determination method may be a method of determining whether or not the target person is a living body, by using the second determination part 2132 that is configured to output a determination result of whether or not the target person is a living body when the image IMG is inputted. The second determination part 2132 may determine whether or not the target person is a living body, on the basis of a temperature distribution in the second image part R2.

As a attention area definition method, for example, a method using segmentation information may be employed, in addition to the method using the facial feature point. Face segmentation information is information indicating positions of pixels where the eyes, the nose, and the like exist.

Furthermore, the first definition part 2121 and the first determination part 2122 may be integral, rather than separate mechanisms. In addition, the second definition part 2131 and the second determination part 2132 may be integral, rather than separate mechanism.

### [2-5: Technical Effect of Biometric Determination Apparatus 20]

The biometric determination apparatus 20 in the second example embodiment determines whether or not the target person is a living body, by utilizing properties that features indicated by the image of a living body is different from features indicated by the image of the counterfeit that is not a living body. The features indicated by the image in the covered area that covers at least a partial area of the face, however, may not indicate the features indicated by the image of a living body, but may be similar to the features indicated by the image of the counterfeit that is not a living body in some cases. Therefore, when the image part of the covered area is used for the biometric determination, erroneous determination may occur.

Therefore, in a case where the face area FR includes the covered area, the biometric determination apparatus 20 in the second example embodiment determines whether or not the target person is a living body, by using the second image part R2 of the image IMG in which at least a part of the covered area is removed from the image part including at least a part of the face area FR. Thus, even in a case where the face area FR includes the covered area, it is possible to accurately determine whether or not the target person is a living body.

In recent years, there has been a demand for biometric determination and biometric authentication with a mask on the face. The mask area MR covered by a mask on the face, corresponds to the covered area that covers at least a partial area of the face. The biometric determination system 2 in the second example embodiment is capable of realizing accurate biometric determination even in a case where there is the mask area MR covered by a mask on the face.

In a case where it is determined whether or not the target person is a living body by using the second image part R2 in which at least a part of the mask area MR is removed from the image IMG, the second image part R2 may be extracted from the image IMG on the basis of the distance between the eyes included in the face. Thus, it is possible to determine whether or not the target person is a living body, by using the image part suitable for the use in the biometric determination.

### (Features Indicated by Image of Living Body)

On the other hand, in a case where the face area FR does not include the mask area MR, when the biometric determination is performed using the image part of the surroundings of the eyes where the face is not covered by a mask, an usable information quantity is reduced compared with the biometric determination using the image part of the face area FR, and it is thus possible to deteriorate the accuracy of the biometric determination. Since the biometric determination apparatus 20 in the second example embodiment determines whether or not the target person is a living body by using the first image part R1 of the image IMG including at least a part of the face area FR in a case where the face area FR does not include the mask area MR, it is possible to accurately determine whether or not the target person is a living body.

In addition, it is conceivable that a preferred biometric determination operation may vary depending on the image used. Therefore, the biometric determination apparatus 20 in the second example embodiment prepares the first determination part used when the covered area that covers the face is not included, and the second determination part used when the covered area that covers the face is included. It is possible to accurately perform the biometric determination by changing the biometric determination operation by switching the definition unit to be used depending on whether or not the covered area is included.

As described above, since the biometric determination apparatus 20 in the second example embodiment is capable of accurately performing the biometric determination and realizing high-accuracy spoofing detection, it is possible to ensure the security of a face recognition technique/technology.

### 3: Third Example Embodiment

Next, a biometric determination apparatus, a biometric determination method, and a recording medium according to a third example embodiment will be described. The following describes the biometric determination apparatus, the biometric determination method, and the recording medium according to the third example embodiment, by using a biometric determination system 3 including a biometric determination apparatus 30 to which the biometric determination apparatus, the biometric determination method, and the recording medium according to the third example embodiment are applied.

### [2-1: Configuration of Biometric Determination System 3]

The biometric determination system 3 in the third example embodiment may have the same configuration as that of the biometric determination system 2 in the second example embodiment. The biometric determination system 3 in the third example embodiment is different from the biometric determination system 2 in the second example embodiment, in the face image used in the biometric determination operation. Specifically, the biometric determination system 3 in the third example embodiment uses a different method of acquiring the face image used. More specifically, lighting control by the image generation apparatus 100 is different. The image generation apparatus 100 in the third example embodiment may be an apparatus including a lighting apparatus and a camera.

### [3-2: Light Emitting Operation Performed by Lighting Apparatus]

The lighting apparatus is configured to illuminate the target person with illumination light. The lighting apparatus is configured to change a lighting condition. The lighting condition may include a condition about the presence or absence of emission of the illumination light, for example. The lighting condition may include the intensity of the illumination light. The lighting condition may include a lighting direction of the illumination light (i.e., a direction in which the target person is illuminated with the illumination light, and a direction of an emission source of the illumination light when viewed from the target person).

For example, a display emits light in an application of displaying an image (where the image may mean at least one of a still image and a video), but the light emitted by the display may be used as the illumination light with which the target person is illuminated. In this case, a display D of a smartphone or tablet terminal owned by the target person may be used as the lighting apparatus. The image generation apparatus 100 may be a smartphone or tablet terminal owned by the target person.

In a case where the display D is used as the lighting apparatus, the lighting condition (especially, the condition about the presence or absence of emission of the illumination light) may include a condition about on/off of the display D. The lighting condition (especially, the condition about the intensity of the illumination light) may include a condition about the brightness (i.e., luminance) of a display surface of the display D. The lighting condition (especially, the condition about the intensity of the illumination light) may include a condition about a change in the brightness (i.e., luminance) of the display surface of the display D.

The lighting condition may include a condition about a display aspect of each display area in a case where the display surface of the display D is divided into a plurality of display areas. The display aspect of the display area may include the brightness (i.e., luminance) of the display area. The display aspect of the display area may include a change in the brightness (i.e., luminance) of the display area. The lighting condition may be set such that all of the plurality of display areas have the same display aspect. Alternatively, the lighting condition may be set such that at least two display aspects of the plurality of display areas are differ from each other.

The display D used as the lighting apparatus may change the lighting condition between an OFF condition in which the display D does not emit light (i.e., the display is turned off) and an ON condition in which the display D emits light (i.e., the display is turned on). The display D used as the lighting apparatus may change the lighting condition between a condition where a color of the display surface of the display D is a first color (i.e., light with a wavelength exhibiting the first color is emitted from the display surface of the display D) and a condition where the color of the display surface of the display D is a second color that is different from the first color (i.e., light with a wavelength exhibiting the second color is emitted from the display surface of the display D). Furthermore, the color of the display D may be changed, for example, from orange to blue to detect a change in the color of a particular face area such as a forehead or cheeks, and depending on a detection result, an uneven state of the face area, a skin, or a material such as silicone may be detected to perform liveness determination. The change in the color may be a change of at least one of R, G, and B.

In addition, in a case where the condition about the display aspect of each display area when the display surface of the display D is divided into a plurality of display areas is used as the lighting condition, the display D used as the lighting apparatus may change the lighting condition between a first display condition in which a combination of display aspects of a plurality of display areas is set to a first combination, and a second display condition in which a combination of display aspects of a plurality of display areas is set to a second combination that is different from the first combination. For example, the display D used as the lighting apparatus may change the lighting condition between a first display condition in which the luminance of a part of the plurality of display areas (e.g., a right half of the display surface of the display D) is set to a first luminance and the luminance of another part of the plurality of display areas (e.g., a right half of the display surface of the display D) is set to a second luminance that is darker than the first luminance, and a second display condition in which the luminance of a part of the plurality of display areas (e.g., the right half of the display surface of the display D) is set to the second luminance and the luminance of another part of the plurality of display areas (e.g., the right half of the display surface of the display D) is set to the first luminance.

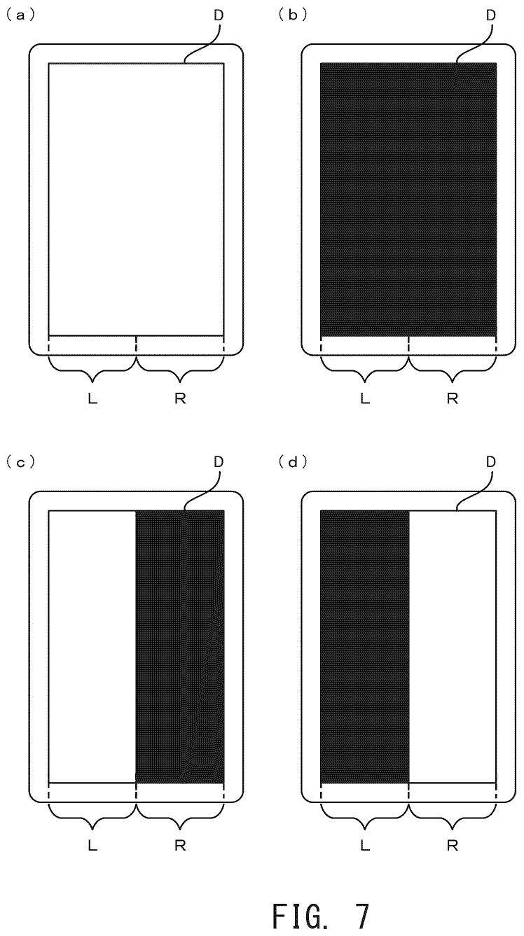

As a specific example, FIG. 7(a) to FIG. 7(d) illustrate the lighting conditions when the display surface of the display D is divided into two display areas L and R arranged in a lateral direction (a left and right direction) of the display surface. FIG. 7(a) illustrates the lighting condition in which both the two display areas L and R emit light (or the luminance of both the two display areas L and R is set to relatively bright/high luminance). FIG. 7(b) illustrates the lighting condition in which both the two display areas L and R do not emit light (or the luminance of both the two display areas L and R is set to a relatively dark/low luminance). FIG. 7(c) illustrates the lighting condition in which the display area L emits light (or the luminance of the display area L is set to relatively bright/high luminance) while the display area R does not emit light (or the luminance of the display area R is set to relatively dark/low luminance). FIG. 7 (d) illustrates the lighting condition in which the display area R emits light (or the luminance of the display area R is set to relatively bright/high luminance) while the display area L does not emit light (or the luminance of the display area L is set to relatively dark/low second luminance).

### [3-3: Definition Operation of Deciding Image Part]

The image acquisition unit 214 acquires a plurality of person images generated by imaging the target person using a plurality of different lighting conditions. The mask area determination unit 211 determines whether or not the face area including the face of the target person captured in at least one of the plurality of person images, includes the covered area that covers at least a partial area of the face. A definition operation of deciding the image part by the biometric determination apparatus 30 in the third example embodiment may be the same as the definition operation of deciding the image portion by the biometric determination apparatus 20 in the second example embodiment illustrated in FIG. 3

### [3-4: Biometric Determination Operation Performed by Biometric Determination Apparatus 30]

In the third example embodiment, the biometric determination apparatus 30 is configured to determine whether or not the target person is a living body, by the target person allowing a camera to image the counterfeit of another person who is impersonated by the target person. In this case, the biometric determination apparatus 30 may determine whether or not the target person is a living body, by utilizing diffuse reflection properties that properties of reflected light from a three-dimensional living body (e.g., reflected light of at least one of the illumination light and ambient light, and the same shall apply hereinafter) is different from properties of reflected light from the counterfeit that is not a living body.

For example, the biometric determination apparatus 30 may calculate the feature quantities that reflect a three-dimensional shape of the face of an imaging subject captured in the image IMG, on the basis of the image IMG. In a case where the target person is a living body, the camera images the target person, and thus, a living body is captured in the image IMG. Therefore, in this case, the biometric determination apparatus 30 calculates the feature quantities corresponding to the three-dimensional shape (e.g., feature quantities representing three-dimensional features) from the image IMG in which a living body is captured. On the other hand, in a case where the target person impersonates or pretends to be another person by using the counterfeit such as a photograph and a display, the camera images the counterfeit, and thus, the counterfeit is captured in the image IMG. Therefore, in this instance, the biometric determination apparatus 30 calculates the feature quantities corresponding to a planar shape (e.g., feature quantities representing planar features) from the image IMG in which the counterfeit is captured. In this way, the biometric determination apparatus 30 may determine whether or not the target person impersonates or pretends to be another person on the basis of the calculated feature quantities.

Note that the biometric determination system 3 may include the biometric determination apparatus 30 and the image generation apparatus 100 as separate apparatuses. Alternatively, the biometric determination system 3 may include a single apparatus including the biometric determination apparatus 30 and the image generation apparatus 100. For example, the biometric determination system 3 may include a smartphone or tablet terminal including the biometric determination apparatus 30 and the image generation apparatus 100

### [3-5: Technical Effect of Biometric Determination Apparatus 30]

The biometric determination apparatus 30 in the third example embodiment determines whether or not the target person is a living body, by using a plurality of person images IMG generated by imaging the target person using a plurality of different lighting conditions. That is, the biometric determination apparatus 30 in the third example embodiment determines whether or not the target person is a living body, by utilizing the diffuse reflection properties that properties of reflected light from a three-dimensional living body is different from properties of reflected light from the counterfeit that is not a living body. On the other hand, properties of reflected light from the mask area MR may be more similar to properties of the reflected light from the counterfeit that is not a living body, than properties of the reflected light from a living body. For this reason, it is not preferable to use the image part based on the reflected light from the mask area MR for the biometric determination. Since the biometric determination apparatus 30 in the third example embodiment changes the determination operation in accordance with whether or not the face area FR includes the mask area MR even in a case of using the plurality of person images IMG generated by imaging the target person using a plurality of different lighting conditions, it is possible to accurately determine whether or not the target person is a living body.

### 4: Fourth Example Embodiment

Next, a biometric determination apparatus, a biometric determination method, and a recording medium according to a fourth example embodiment will be described. The following describes the biometric determination apparatus, the biometric determination method, and the recording medium according to the fourth example embodiment, by using a authentication system 4 including an authentication apparatus 40 to which the biometric determination apparatus, the biometric determination method, and the recording medium according to the fourth example embodiment are applied.

The authentication 4 may be used to manage an entry/exit of the target person for a restricted area, for example. Specifically, the restricted area is an area where the target person who satisfies a predetermined entry condition is permitted to enter, but the target person who does not satisfy the predetermined entry condition is not permitted to enter (i.e. is prohibited). In this case, the authentication apparatus 40 may authenticate the target person by determining whether or not the target person captured in the image IMG is the same as a person who is permitted to enter the restricted area (e.g., a person registered in advance as the person who satisfies the entry condition). In this instance, in a case where the target person is determined to be the same as the person who is permitted to enter the restricted area (i.e., in a case where authentication is successful), the authentication apparatus 40 may permit the target person to enter the restricted area. As an example, the authentication apparatus 40 may set a state of an entry/exit limiting apparatus (e.g., a gate apparatus or door apparatus) that is configured to limit the passage of the target person, into an open state in which the target person is able to pass through the entry/exit limiting apparatus. On the other hand, in a case where the target person is determined not to be the same as the person who is permitted to enter the restricted area (i.e., in a case where authentication is failed), the authentication apparatus 40 may prohibit the target person from entering the restricted area. As an example, the authentication apparatus 40 may set the state of the entry/exit limiting apparatus into a closed state in which the target person is unable to pass through the entry/exit limiting apparatus. Furthermore, even when the authentication of the target person authentication is successful, in a case where the target person captured in the image IMG is determined not to be a living body, the authentication system 4 may prohibit the target person from entering the restricted area.

In a case where the authentication system 4 is used to manage the entry/exit of the target person for the restricted area, the image generation apparatus 100 may image the target person who is about to enter the restricted area. As an example, the image generation apparatus 100 may be placed in the vicinity of the entry/exit limiting apparatus and may image the target person located in the vicinity of the entry/exit limiting apparatus to enter the restricted area. In this instance, the image generation apparatus 100 may image the target person moving toward the entry/exit limiting apparatus. The image generation apparatus 100 may image the target person moving toward the image generation apparatus 100 located in the vicinity of the entry/exit limiting apparatus. Alternatively, the image generation apparatus 100 may image the target person standing still in front of the entry/exit limiting apparatus. The image generation apparatus 100 may image the target person standing still in front of the image generation apparatus 100 located in the vicinity of the entry/exit limiting apparatus.

### [4-1: Configuration of Authentication Apparatus 40]

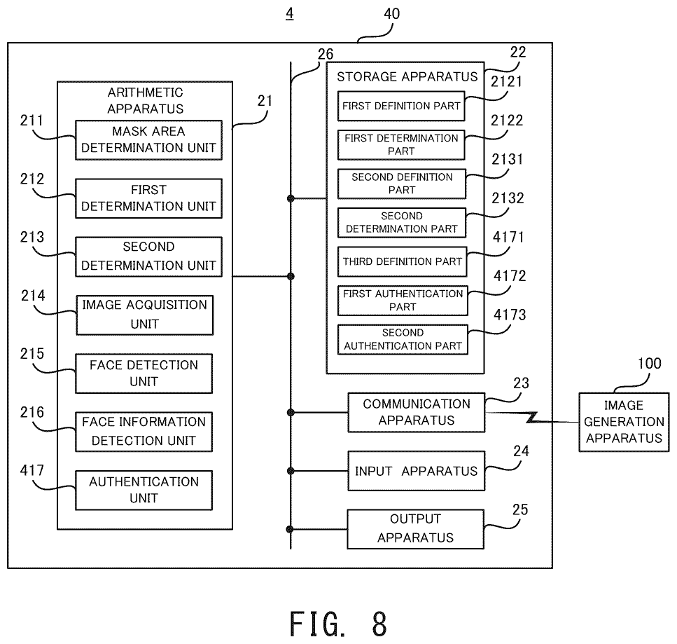

As illustrated in FIG. 8, the authentication apparatus 40 in the fourth example embodiment is different from the biometric determination apparatus 20 in the second example embodiment (or from the biometric determination apparatus 30 in the third example embodiment), in that the arithmetic apparatus 21 includes an authentication unit 417 and in that the storage apparatus 22 stores a third definition part 4171, a first authentication part 4172, and a second authentication part 4173. The authentication unit 417 authenticates the target person on the basis of an image. The third definition part 4171 may be a definition part that defines a third image part R3 of the image IMG used by the authentication unit 417 to authenticate the target person. The first authentication part 4172 may be an authentication part that authenticates the target person who is not wearing a mask. The first authentication part 4172 may be an authentication part constructed by machine learning of the authentication of the target person, by using the face image of the face without a mask. In addition, the second authentication part 4173 may be an authentication part that authenticates the target person with a mask. The second authentication part 4173 may be an authentication part constructed by machine learning of the authentication of the target person, by using the face image of the face with a mask. That is, the two authentication parts may be prepared: the first authentication part 4172 that performs machine learning by using the face image of the face without a mask, and the second authentication part 4173 that performs machine learning by using the face image of the face with a mask. Other features of the authentication apparatus 40 may be the same as those of the biometric determination apparatus 20 (or the biometric determination apparatus 30)

For example, in a case where the first determination unit 212 or the second determination unit 213 performs the biometric determination using an image captured by a visible light camera, the image generation apparatus 100 may include a visible light camera. In this case, the first determination unit 212 or the second determination unit 213 may perform the biometric determination on the basis of the image captured by the visible light camera, and the authentication unit 417 may also authenticate the target person on the basis of the image captured by the visible light camera. In addition, the biometric determination using the image captured by the visible light camera may be referred to as luminance difference liveness.

On the other hand, for example, in a case where the first determination unit 212 or the second determination unit 213 performs the biometric determination using an infrared image, the image generation apparatus 100 may include an infrared camera and a visible light camera. In this case, the first determination unit 212 or the second determination unit 213 may perform the biometric determination based on the infrared image captured by the infrared camera, and the authentication unit 417 may authenticate the target person on the basis of an image captured by the visible light camera. In addition, the biometric determination using the infrared image may be referred to as infrared image liveness.

### [4-2: Biometric Determination Operation and Biometric Authentication Operation Performed by Authentication Apparatus 40]

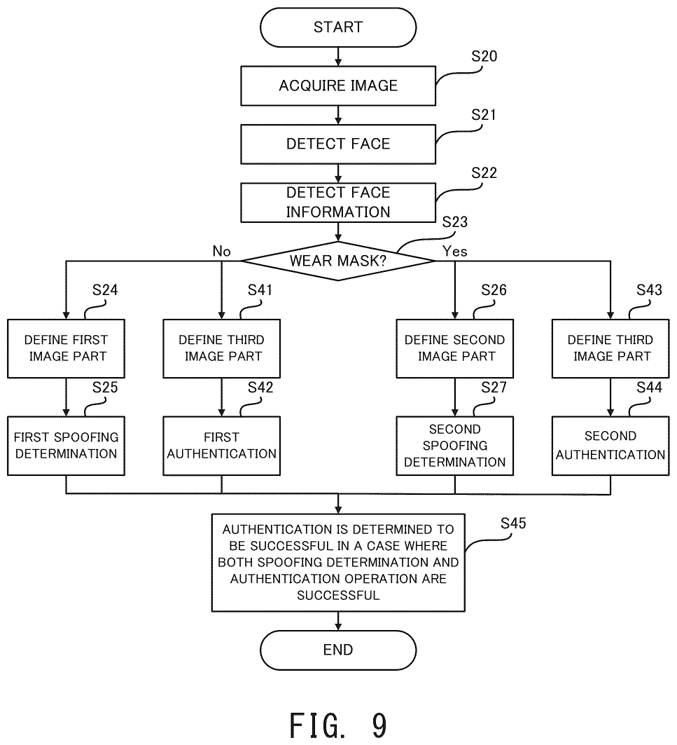

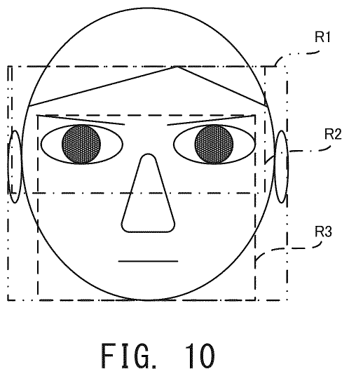

Hereinafter, with reference to FIG. 9, a flow of a biometric determination operation and a biometric authentication operation in the fourth example embodiment will be described. FIG. 9 is a flowchart illustrating the flow of the biometric determination operation and the biometric authentication operation in the fourth example embodiment. Hereinafter, a case where the first determination unit 212 or the second determination unit 213 performs the luminance difference liveness will be described as an example.

A step S20 to a step S27 may be the same as the step S20 to the step S27 in the second example embodiment illustrated in FIG. 3, or the step S20 to the step S27 in the third example embodiment. That is, even in the fourth example embodiment, the spoofing determination described in at least one of the second example embodiment and the third example embodiment, may be performed.

When the mask area determination unit 211 determines that the face area FR does not include the covered area (the step S23: No), a step S41 and a step S42 are performed in parallel with the step S24 and the step S25. That is, the authentication unit 417 defines the third image part R3 by using the third definition part 4171 (step S41), and authenticates the target person by the first authentication method by using the first authentication part 4172 (step S42).

In addition, when the mask area determination unit 211 determines that the face area FR includes the covered area (the step S23: Yes), a step S43 and a step S44 are performed in parallel with the step S26 and the step S27. That is, the authentication unit 417 defines the third image part R3 by using the third definition part 4171 (step S43), and authenticates the target person by the second authentication method by using the second authentication unit 4173 (step S44). In the fourth example embodiment, the third image part R3 used for the authentication may be the same, regardless of whether or not the target person wears a mask.

In a case where the target person is determined to be a living body in the spoofing determination in the step S25 and the authentication operation in the step S42 is successful, or in a case where the target person is determined to be a living body in the spoofing determination in the step S27 and the authentication operation in the step S44 is successful, the authentication of the target person is determined to be successful (step S45). That is, in a case where one of the operations is failed, the authentication of the target person is determined to be failed.

In the above example embodiment, described is a case where the spoofing determination operation and the authentication operation are performed in parallel, but the operation may be performed in the order of the step S24, the step S25, the step S41, and the step S42, or in the order of the step S26, the step S27, the step S43, and the step S44, for example.

For example, the first authentication or the second authentication may be performed by the authentication unit 417 before the determination in the step S23. In this case, when the first authentication or the second authentication by the authentication unit 417 is completed, the determination in the step 23 and the step S24 and the step S25, or the step S26 and the step S27 may be performed. Alternatively, for example, when the first authentication or the second authentication by the authentication unit 417 is completed, the step S24 and the step S25, or the o step S26 and the step S27 may be performed. Since the operation is shifted to another operation only when the first authentication or the second authentication by the authentication unit 417 is completed, it is possible to reduce unnecessary processing.

Furthermore, for example, the biometric determination by the first determination unit 212 or the second determination unit 213 may be performed before the determination in the step S23. In this case, when the biometric determination by the first determination unit 212 or the second determination unit 213 is completed, the determination in the step 23 and the step S41 and the step S42, or the step S43 and the step S44 may be performed. Alternatively, for example, when the biometric determination by the first determination unit 212 or the second determination unit 213 is completed, the step S41 and the step S42, or the step S43 and the step S44 may be performed. Since the operation is shifted to another operation only when the biometric determination by the first determination unit 212 or the second determination unit 213 is completed, it is possible to reduce unnecessary processing.

Mask area determination by the mask area determination unit 211 and face recognition by the authentication unit 417 may be performed on the basis of one same image. In this case, a mask area determination operation and a face recognition operation may be performed before the biometric determination operation. The biometric determination operation by the first determination unit 212 or the second determination unit 213 may be started when a predetermined number of images are acquired.

In addition, in a case where the first determination portion 212 or the second determination portion 213 performs the infrared image liveness, the camera that captures an image used for a liveness determination operation is different from the camera that captures an image used for the face recognition. Therefore, the timing of starting the liveness determination operation and the face recognition operation may be different from the timing of completing each of the operations.

### [4-3: Conceptual Diagram of Image Part]

In the fourth example embodiment, the size of an image part of the image used by the first determination unit 212 to determine whether or not the target person is a living body, may be greater than the size of an image part of the image used by the authentication unit 417 to authenticate the target person. The first determination unit 212 may extract the first image part R1 from the face area FR so as to be greater in size than the image part used by the authentication unit 417 to authenticate the target person.

FIG. 10 is a conceptual diagram of the image part in the fourth example embodiment. In FIG. 10, an area R1 surrounded by a two-dot chain line indicates the first image part including at least a part of the face area FR of the image IMG, and illustrates the image part used for the spoofing determination operation of the target person who is not wearing a mask. Since an information quantity that can be used for the biometric determination is larger in extracting a larger part in which a skin is not covered in the face area FR, it is preferable that the image part used for the biometric determination is larger. In addition, since a part that is likely to be covered by hair can be considered as the covered area, it may be excluded from the image part.

An area R3 surrounded by a dashed line indicates the third image part of the image IMG used by the authentication unit 417 to authenticate the target person, and exemplifies the image part used for the authentication operations.

That is, the first image part R1 may include another image part of the face area FR in addition to the third image part R3. Thus, it is possible to increase the size of the image part that can be used for the biometric determination and to improve the accuracy of the biometric determination.

In addition, an example of the liveness determination includes a method of determining whether the target person is a living body by estimating a pulse on the basis of a difference between a plurality of images continuously captured. Even in a case where this method is employed, it is possible to improve the accuracy of the biometric determination by increasing the size of the image part that can be used.

Furthermore, an area R2 surrounded by a two-dot chain line indicates the second image part in which at least a part of the mask area MR is removed from the first image part R1, and exemplifies the image part used for the spoofing determination operation of the face image of the face with a mask.

### [4-3: Technical Effect of Authentication Apparatus 40]

Since the authentication apparatus 40 in the fourth example embodiment performs the biometric determination described in at least one of the second example embodiment and the third example embodiment, it is possible to more accurately determine whether or not the target person is a living body and to accurately authenticate the target person who is a living body.

In addition, the authentication apparatus 40 in the fourth example embodiment makes the size of the image part of the image used by the first determination unit 212 to determine whether or not the target person is a living body, larger than the size of the image part of the image used by the authentication portion 417 to authenticate the target person. Therefore, it is possible to improve the accuracy of the biometric determination.

In each of the above example embodiments, a case where the covered area is the mask area in which the face is covered by a mask, is described, but even in a case where there is a covered area covered by another object other than the mask, the above example embodiments can be applied.

In each of the above example embodiments, a case where the biometric determination apparatus includes a mechanism of one type of biometric determination and performs the one type of biometric determination, is described. The biometric determination apparatus, however, may include a mechanism(s) of a plurality of types of biometric determination, may perform the plurality of types of biometric determination, and may determine whether or not the target person is a living body on the basis of a plurality of determination results.

The plurality of types of biometric determination may include at least one of first biometric determination in which at least one of the determination part used for the biometric determination and the image part used for the biometric determination is switched, in accordance with whether or not at least partial area of the face area is covered, and second biometric determination in which at least one of the determination part used for the biometric determination and the image part used for the biometric determination is switched. That is, in a case where the first biometric determination is performed, at least one of the determination part used for the biometric determination and the image part used for the biometric determination may not be switched in accordance with whether or not at least a partial area of the face area is covered. On the other hand, in a case where the second biometric determination is performed, at least one of the determination part used for the biometric determination and the image part used for the biometric determination may be switched in accordance with whether or not at least a partial area of the face area is covered.

That is, the biometric determination apparatus may include: a first biometric determination unit that determines whether or not the target person is a living body by using the first image part R1 in a case where the face area is covered; and a second biometric determination unit that determines whether or not the target person is a living body by using the second image part R2 in a case where the face area is covered. In this instance, the second biometric determination unit includes the first determination unit 212 and the second determination unit 213.

The first biometric determination may include a technique/method of instructing the target person to perform an operation such as shaking the head and detecting the operation of the target person, a technique/method of detecting a change in a line of sight of the target person, a technique/method of detecting a change in the reflection of an iris in the eye of the target person, and the like. The second biometric determination may include the biometric determination based on the temperature distribution in the image part, the luminance difference liveness, the infrared image liveness, and the like.

In a case where the second biometric determination is performed and when at least a partial area of the face area is not covered, and in a case where the first biometric determination is performed, the biometric determination may be performed by using the first image part R1 illustrated in FIG. 10, for example. On the other hand, in a case where the second biometric determination is performed and when at least a partial area of the face area is covered, the biometric determination may be performed by using the second image part R2 illustrated in FIG. 10, for example.

In addition, since the biometric determination apparatus uses different image in accordance with the type of the biometric determination to be performed, the image generation apparatus may include an infrared camera and a visible light camera.

### 5: Supplementary Notes

With respect to the example embodiments described above, the following Supplementary Notes are further disclosed.

### [Supplementary Note 1]

A biometric determination apparatus including:
a covered area determination unit that determines whether or not a face area including a face of a target person captured in an image generated by imaging the target person includes a covered area that covers at least a partial area of the face;
a first determination unit that determines whether or not the target person is a living body by a first determination method using the image, in a case where the covered area determination unit determines that the face area does not include the covered area; and
a second determination unit that determines whether or not the target person is a living body by a second determination method that uses the image and that is different from the first determination method, in a case where the covered area determination unit determines that the face area includes the covered area.

### [Supplementary Note 2]

The biometric determination apparatus according to Supplementary Note 1, wherein
the first determination method is a method of determining whether or not the target person is a living body, by using a first image part of the image including at least a part of the face image, and
the second determination method is a method of determining whether or not the target person is a living body, by using a second image part in which at least a part of a covered area is removed from the first image part.

### [Supplementary Note 3]

The biometric determination apparatus according to Supplementary Note 2, wherein the second determination unit extracts the second image part from the image on the basis of a distance between eyes included in the face.

### [Supplementary Note 4]

The biometric determination apparatus according to Supplementary Note 3, further including a decision unit that decides a size of the second image part to be extracted, and a position of the second image part, on the basis of the distance between the eyes included in the face.

### [Supplementary Note 5]

The biometric determination apparatus according to any one of Supplementary Notes 2 to 4, wherein the second determination unit extracts the second image part from the image on the basis of both side parts of a lower part of a dorsum of a nose included in the face.

### [Supplementary Note 6]

The biometric determination apparatus according to Supplementary Note 5, further including a decision unit that decides a lower limit part of the second image part to be extracted, on the basis of the both side parts of the lower part of the dorsum of the nose included in the face.

### [Supplementary Note 7]

The biometric determination apparatus according to any one of Supplementary Notes 2 to 6, further including an authentication unit that authenticates the target person on the basis of the image, wherein the first determination unit extracts the first image part from the image so as to be greater in size than an image part used by the authentication unit to authenticate the target person.

### [Supplementary Note 8]

The biometric determination apparatus according to any one of Supplementary Notes 2 to 7, further including:
a first biometric determination unit that determines whether or not the target person is a living body, by using the first image part, in a case where the face area is covered; and
a second biometric determination unit that determines whether or not the target person is a living body, by using the second image part, in a case where the face area is covered, wherein
the second biometric determination unit includes the first determination unit and the second determination unit.

### [Supplementary Note 9]

The biometric determination apparatus according to any one of Supplementary Notes 1 to 8, wherein the image is an infrared image.

### [Supplementary Note 10]

The biometric determination apparatus according to any one of Supplementary Notes 1 to 9, wherein
the first determination method is a method of determining whether or not the target person is a living body, by using a first determination part that is configured to output a determination result of whether or not the target person is a living body in a case where the image is inputted, and
the second determination method is a method of determining whether or not the target person is a living body, by using a second determination part that is different from the first determination part and that is configured to output a determination result of whether or not the target person is a living body in a case where the image is inputted.

### [Supplementary Note 11]

The biometric determination apparatus according to any one of Supplementary Notes 1 to 10, wherein the covered area is a mask area in which the face is covered by a mask on the face.

### [Supplementary Note 12]

The biometric determination apparatus according to any one of Supplementary Notes 1 to 11, further including an image acquisition unit that acquires a plurality of person images generated by imaging the target person using a plurality of different lighting conditions, wherein the image is at least one of the plurality of persons images.

### [Supplementary Note 13]

The biometric determination apparatus according to any one of Supplementary Notes 1 to 12, further including an authentication unit that authenticates the target person on the basis of the image, wherein
a size of an image part of the image used by the first determination unit to determine whether or not the target person is a living body is greater than a size of an image part of the image used by the authentication unit to authenticate the target person.

### [Supplementary Note 14]

A biometric determination method including:
determining whether or not a face area including a face of a target person captured in an image generated by imaging the target person includes a covered area that covers at least a partial area of the face;
determining whether or not the target person is a living body by a first determination method using the image, in a case where the covered area determination unit determines that the face area does not include the covered area; and determining whether or not the target person is a living body by a second determination method that uses the image and that is different from the first determination method, in a case where the covered area determination unit determines that the face area includes the covered area.

### [Supplementary Note 15]

A recording medium on which a computer program that allows a computer to execute a biometric determination method is recorded, the biometric determination method including:
determining whether or not a face area including a face of a target person captured in an image generated by imaging the target person includes a covered area that covers at least a partial area of the face;
determining whether or not the target person is a living body by a first determination method using the image, in a case where the covered area determination unit determines that the face area does not include the covered area; and
determining whether or not the target person is a living body by a second determination method that uses the image and that is different from the first determination method, in a case where the covered area determination unit determines that the face area includes the covered area.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is not limited to the examples described above and is allowed to be changed, if desired, without departing from the essence or spirit of this disclosure which can be read from the claims and the entire identification. A biometric determination apparatus, a biometric determination method, and a recording medium with such changes are also intended to be within the technical scope of this disclosure.

### DESCRIPTION OF REFERENCE CODES

1 Biometric determination apparatus
11 Covered area determination unit
12 First determination unit
13 Second determination unit
2 Biometric determination system
20 Biometric determination apparatus
100 Image generation apparatus
211 Mask area determination unit
212 First determination unit
2121 First definition part
2122 First determination part
213 Second determination unit
2131 Second definition part
2132 Second determination unit
214 Image acquisition unit
215 Face detection unit
216 Face information detection unit
4 Authentication system
40 Authentication apparatus
417 Authentication unit
4171 Third definition part
4172 First authentication part
4173 Second authentication part
IMG Image
FR Face area
MR Mask area
R1 First image part
R2 Second image part
R3 Third image Part
D Display

What is claimed is:

1. A biometric determination apparatus comprising:
at least one memory that is configured to store instructions; and
at least one processor that is configured to execute the instructions to:
determine whether or not at least a partial area of a face area including a face of a target person in an image is covered;
determine whether or not the target person is a living body by a first determination method using the image, in a case where the face area is not covered as a first determining; and
determine whether or not the target person is a living body by a second determination method that uses the image and that is different from the first determination method, in a case where the face area is covered as a second determining.

2. The biometric determination apparatus according to claim 1, wherein
the first determination method is a method of determining whether or not the target person is a living body, by using a first image part of the image including at least a part of the face image, and
the second determination method is a method of determining whether or not the target person is a living body, by using a second image part in which at least a part of a covered area is removed from the first image part.

3. The biometric determination apparatus according to claim 2, wherein the at least one processor is configured to execute the instructions to extract the second image part from the image on the basis of a distance between eyes included in the face.

4. The biometric determination apparatus according to claim 3, wherein the at least one processor is configured to execute the instructions to decide a size of the second image part to be extracted, and a position of the second image part, on the basis of the distance between the eyes included in the face.

5. The biometric determination apparatus according to claim 2, wherein the at least one processor is configured to execute the instructions to extract the second image part from the image on the basis of both side parts of a lower part of a dorsum of a nose included in the face.

6. The biometric determination apparatus according to claim 5, wherein the at least one processor is configured to execute the instructions to decide a lower limit part of the second image part to be extracted, on the basis of the both side parts of the lower part of the dorsum of the nose included in the face.

7. The biometric determination apparatus according to claim 2, wherein the at least one processor is configured to execute the instructions to: authenticate the target person on the basis of the image; and
extract the first image part from the image so as to be greater in size than an image part used to authenticate the target person.

8. The biometric determination apparatus according to claim 2, wherein the at least one processor is configured to execute the instructions to:
determine whether or not the target person is a living body, by using the first image part, in a case where the face area is covered as a first biometric determining; and
determine whether or not the target person is a living body, by using the second image part, in a case where the face area is covered as a second biometric determining, wherein
the second biometric determining includes the first determining and the second determining.

9. The biometric determination apparatus according to claim 1, wherein the image is an infrared image.

10. The biometric determination apparatus according to claim 1, wherein
the first determination method is a method of determining whether or not the target person is a living body, by using a first determination part that is configured to output a determination result of whether or not the target person is a living body in a case where the image is inputted, and
the second determination method is a method of determining whether or not the target person is a living body, by using a second determination part that is different from the first determination part and that is configured to output a determination result of whether or not the target person is a living body in a case where the image is inputted.

11. The biometric determination apparatus according to claim 1, wherein a covered area in which at least a partial area of the face area is covered, is a mask area in which the face is covered by a mask on the face.

12. The biometric determination apparatus according to claim 1, wherein
the at least one processor is configured to acquire a plurality of person images generated by imaging the target person using a plurality of different lighting conditions, and
the image is at least one of the plurality of persons images.

13. A biometric determination method comprising:
determining whether or not at least a partial area of a face area including a face of a target person in an image is covered;
determining whether or not the target person is a living body by a first determination method using the image, in a case where the face area is not covered; and
determining whether or not the target person is a living body by a second determination method that uses the image and that is different from the first determination method, in a case where the face area is covered.

14. A non-transitory recording medium on which a computer program that allows a computer to execute a biometric determination method is recorded, the biometric determination method including:
determining whether or not at least a partial area of a face area including a face of a target person in an image is covered;
determining whether or not the target person is a living body by a first determination method using the image, in a case where the face area is not covered; and
determining whether or not the target person is a living body by a second determination method that uses the image and that is different from the first determination method, in a case where the face area is covered.
